(19) United States
(12) Patent Application Publication
(10) Pub. No.: US 2026/0155560 A1
(43) Pub. Date: Jun. 4, 2026

(54) RESIN COMPOSITION, ELECTRONIC COMPONENT DEVICE, AND METHOD FOR MANUFACTURING RESIN COMPOSITION

(71) Applicant: RESONAC CORPORATION, Tokyo (JP)

(72) Inventors: Ayumi NAKAYAMA, Minato-ku, Tokyo (JP); Masashi YAMAURA, Minato-ku, Tokyo (JP)

(73) Assignee: RESONAC CORPORATION, Tokyo (JP)

(21) Appl. No.: 18/861,570

(22) PCT Filed: Sep. 4, 2023
(86) PCT No.: PCT/JP2023/032242

§ 371 Date: Oct. 29, 2024

(51) Int. Cl. H01Q 1/40; C08G 59/08; C08G 59/24; C08G 59/62; C08K 3/04; C08K 3/22; C08K 3/24; C08L 63/00

(52) U.S. Cl. CPC H01Q 1/40; C08G 59/08; C08G 59/245; C08G 59/621; C08K 3/04; C08K 3/22; C08K 3/24; C08L 63/00; C08K 2003/2227; C08K 2201/005; C08K 2201/011

(57) ABSTRACT

A resin composition, including a curable resin and carbon particles, wherein the carbon particles satisfy at least one of (1) and (2) as follows: (1) a pH is 5.0 or less; and (2) an average particle size is 80 nm or more.

### BACKGROUND

### Technical Field

The disclosure relates to a resin composition, an electronic component device, and a method for manufacturing a resin composition.

### Description of Related Art

In recent years, in the field of wireless communication, radio waves have been becoming higher in frequency in response to an increase in the number of channels and an increase in the amount of information transmitted. Among the transmission losses of electrical signals used in wireless communication, the amount of loss (dielectric loss) involving insulators such as circuit sealing materials increases proportionally to the product of the frequency of radio waves, the square root of the relative dielectric constant of the insulator, and the dielectric loss tangent of the insulator. Therefore, in the case where the frequency of radio waves increases, reducing the relative dielectric constant or dielectric loss tangent of the insulator is becoming more important from the viewpoint of suppressing the transmission loss of electrical signals.

For example, Patent Document 1 and Patent Document 2 disclose resin compositions containing an active ester resin as a curing agent for epoxy resin, and insulators obtained by curing the resin compositions have suppressed dielectric loss tangents to be low.
Patent Document 1: Japanese Patent Application Laid-Open Publication No. 2012-246367
Patent Document 2: Japanese Patent Application Laid-Open Publication No. 2014-114352

### SUMMARY

### Issues to be Solved by the Invention

Although the cured products of the resin compositions described in Patent Documents 1 and 2 have low dielectric loss tangents and can contribute to the reduction of dielectric loss, there is a limit to the amount of the curing agent that can be contained in the resin composition. Therefore, the development of a technology for reducing the dielectric loss tangent of a cured product by means other than a curing agent is desired.

The disclosure has been made in view of the above circumstances and aims to provide a resin composition that yields a cured product with a low dielectric loss tangent, an electronic component device obtained by using the resin composition, and a method for manufacturing the resin composition.

### Means for Solving the Problem

The specific means for solving the above problem include the following aspects.

<1> A resin composition includes a curable resin and carbon particles. The carbon particles satisfy at least one of (1) and (2) as follows:
(1) a pH is 5.0 or less; and
(2) an average particle size is 80 nm or more.

<2> In the resin composition according to <1>, the carbon particles at least satisfy (1).

<3> In the resin composition according to <1>, the carbon particles at least satisfy (2).

<4> In the resin composition according to any one of <1> to <3>, the carbon particles comprise carbon black.

<5> In the resin composition according to any one of <1> to <4>, the curable resin comprises epoxy resin.

<6> An electronic component device includes: a support member;
an electronic component disposed on the support member; and
a cured product of the resin composition according to any one of <1> to <5> that seals the electronic component

<7> In the electronic component device according to <6>, the electronic component includes an antenna.

<8> A method for manufacturing a resin composition includes: mixing a curable resin and carbon particles. The carbon particles satisfy at least one of (1) and (2) as follows:
(1) a pH is 5.0 or less; and
(2) an average particle size is 80 nm or more.

### Inventive Effects

According to the disclosure, a resin composition that provides a cured product with a low dielectric loss tangent, an electronic component device obtained by using the resin composition, and a method for manufacturing the resin composition are provided.

### DESCRIPTION OF THE EMBODIMENTS

In the disclosure, the term “step” includes not only steps independent from other steps, but also steps that may not be clearly distinguishable from other steps, as long as the purpose of the step is achieved.

In the disclosure, numerical ranges indicated using “˜” or “to” include the values before and after “˜” or “to” as the minimum and maximum values, respectively.

In the numerical ranges described stepwise in the disclosure, an upper limit or lower limit described in one numerical range may be replaced with an upper limit or lower limit value of another stepwise described numerical range. Additionally, in the numerical ranges described in the disclosure, the upper limit or lower limit of the numerical range may be replaced with a value shown in the examples.

In the disclosure, each component may contain multiple types of corresponding substances. In the case where multiple types of substances corresponding to the respective components are present in the composition, the content ratio or the content of each component refers to the total content ratio or the total content of the multiple types of substances present in the composition, unless otherwise specified.

In the disclosure, particles corresponding to respective components may be of multiple types. In the case where multiple types of particles corresponding to each component are present in the composition, unless otherwise specified, the particle size of each component means the value for the mixture of the multiple types of particles present in the composition.

The following describes in detail the embodiments for implementing the disclosure. However, the disclosure is not limited to the following embodiments. In the following embodiments, the constituent elements (including element steps, etc.) are not essential unless specifically stated. The same applies to numerical values and the ranges thereof, which do not limit the disclosure.

### <Resin Composition>

The resin composition according to an embodiment of the disclosure includes a curable resin and carbon particles. The carbon particles satisfy at least one of the following (1) and (2).
(1) The pH is 5.0 or less
(2) The average particle size is 80 nm or more

Resin compositions used for sealing electronic components may contain carbon particles such as carbon black for coloring, light shielding, and laser marking assistance.

Carbon particles are generally conductive, and therefore are considered to be one of the factors that increase the dielectric loss tangent of the cured product.

In the embodiment, the carbon particles contained in the resin composition satisfy at least one of (1) and (2). This is considered to contribute to the reduction of the dielectric loss tangent of the cured product of the resin composition.

The following describes each component constituting the resin composition. The resin composition of the embodiment contains a curable resin and carbon particles, and may contain other components as necessary.

### (Carbon Particles)

The resin composition of the embodiment includes carbon particles.

In the present disclosure, carbon particles refer to particulate substances in which 90 mass % or more of all the elements are carbon.

As carbon particles, examples may include amorphous carbon particles such as carbon black, carbon fiber, and activated carbon, and crystalline carbon particles such as fullerene, carbon nanotubes, graphene, and graphite. Among the types, amorphous carbon particles are preferred, and carbon black is more preferred.

The type of carbon black is not particularly limited and can be selected according to the desired characteristics. Carbon black can be selected, for example, from furnace black, channel black, acetylene black, thermal black, and the like.

The carbon particles contained in the resin composition may be of a single type or two or more types.

From the viewpoint of reducing the dielectric loss tangent of the cured product of the resin composition, the pH of the carbon particles is preferably 5.0 or less.

Carbon particles with a pH of 5.0 or less are considered to contain a relatively large amount of polar groups such as carboxyl groups, and the electron transfer between carbon particles is likely to be inhibited by the polar groups (which may be in a state reacted with components in the resin composition). As a result, it is considered that the dielectric loss tangent of the cured product of the resin composition containing carbon particles is reduced.

The pH of the carbon particles is more preferably 4.5 or less, and even more preferably 4.0 or less.

From the viewpoint of preventing corrosion of metal components such as wires, the pH of the carbon particles is preferably 3.0 or higher.

In the disclosure, the pH of the carbon particles is a value measured at 25° C. and is measured by the boiling extraction method specified in JIS K5101-17-1(2004).

From the viewpoint of reducing the dielectric loss tangent of the cured product of the resin composition, the average particle size of the carbon particles is preferably 80 nm or more. Carbon particles with an average particle size of 80 nm or more are considered to have a relatively small specific surface area, and the electron transfer between carbon particles is less likely to occur. As a result, it is considered that the dielectric loss tangent of the cured product of the resin composition containing carbon particles is reduced.

The average particle size of the carbon particles is more preferably 90 nm or more, and even more preferably 100 nm or more.

From the viewpoint of dispersibility of carbon particles, the average primary particle size of the carbon particles is preferably 1000 nm or less, and more preferably 500 nm or less.

In the disclosure, the average particle size of the carbon particles is measured by image analysis method.

The method of image analysis is not particularly limited. Examples may include a method of observing carbon particles with an optical microscope or an electron microscope. The counting of carbon particles can be performed visually or using an image analysis system.

From the viewpoint of measurement accuracy, the image analysis is performed under conditions where the total number of carbon particles as the measurement target is 100 or more, and the observation magnification is 1000 times or more.

The arithmetic mean of the particle sizes of the carbon particles as the measurement target is considered as the average particle size of the carbon particles.

The particle size of the carbon particles as the measurement target is defined as the equivalent circular diameter of the observed particles.

In the case where carbon particles form an aggregate, the particle size of the carbon particles is defined as the particle size of the particles (primary particles) forming the aggregate.

The content ratio of carbon particles contained in the resin composition is not particularly limited.

From the viewpoint of achieving desired objectives such as coloring, the content ratio of carbon particles is preferably 0.1 mass % or more of the entire resin composition, and more preferably 0.3 mass % or more.

From the viewpoint of suppressing the dielectric loss tangent of the cured product to be low, the content ratio of carbon particles is preferably 5 mass % or less of the entire resin composition, and more preferably 1 mass % or less.

### (Curable Resin)

The resin composition in the embodiment includes the curable resin.

The curable resin may be either a thermosetting resin or a photo-curable resin, but from the viewpoint of mass productivity, a thermosetting resin is preferred.

As the thermosetting resin, examples may include epoxy resin, phenol resin, melamine resin, urea resin, unsaturated polyester resin, alkyd resin, urethane resin, polyimide resin such as bismaleimide resin, polyamide resin, polyamideimide resin, silicone resin, acrylic resin, and the like. From the viewpoint of moldability and electrical properties, the thermosetting resin is preferably at least one selected from the group consisting of epoxy resin and polyimide resin, more preferably at least one selected from the group consisting of epoxy resin and bismaleimide resin, and even more preferably epoxy resin.

The resin composition may contain only one type of curable resin, or may contain two or more types.

The following describes the epoxy resin as an example of the curable resin.

### —Epoxy Resin—

The resin composition preferably includes epoxy resin as the curable resin.

In the case where the resin composition includes epoxy resin as the curable resin, the content ratio of the epoxy resin with respect to the entirety of the curable resin is preferably 80 mass % or more, more preferably 90 mass % or more, and even more preferably 95 mass % or more.

The type of the epoxy resin is not particularly limited as long as it possesses an epoxy group in the molecule.

Specifically, as the epoxy resin, examples may include: a novolac-type epoxy resin (phenol novolac-type epoxy resin, ortho-cresol novolac-type epoxy resin, etc.) obtained by epoxidizing a novolac resin produced by condensation or co-condensation under an acidic catalyst of at least one phenolic compound selected from the group consisting of a phenol compound such as phenol, cresol, xylenol, resorcinol, catechol, bisphenol A, bisphenol F, and a naphthol compound such as α-naphthol, β-naphthol, dihydroxynaphthalene, with an aliphatic aldehyde compound such as formaldehyde, acetaldehyde, propionaldehyde; a triphenylmethane-type epoxy resin obtained by epoxidizing triphenylmethane-type phenol resin produced by condensation or co-condensation under an acidic catalyst of the phenolic compound with an aromatic aldehyde compound such as benzaldehyde, salicylaldehyde; a copolymer-type epoxy resin obtained by epoxidizing a novolac resin produced by co-condensation under an acidic catalyst of the phenol compound and naphthol compound with an aldehyde compound; a diphenylmethane-type epoxy resin which is a diglycidyl ether of bisphenol A, bisphenol F, etc.; a biphenyl-type epoxy resin which is a diglycidyl ether of alkyl-substituted or unsubstituted biphenol; a stilbene-type epoxy resin which is a diglycidyl ether of a stilbene-based phenol compound; a sulfur atom-containing epoxy resin which is a diglycidyl ether of bisphenol S, etc.; an epoxy resin which is a glycidyl ether of alcohol such as butanediol, polyethylene glycol, polypropylene glycol; a glycidyl ester-type epoxy resin which is a glycidyl ester of a polyvalent carboxylic acid compound such as phthalic acid, isophthalic acid, tetrahydrophthalic acid; a glycidylamine-type epoxy resin in which an active hydrogen bonded to a nitrogen atom of aniline, diaminodiphenylmethane, isocyanuric acid, etc. is substituted with a glycidyl group; a dicyclopentadiene-type epoxy resin obtained by epoxidizing a co-condensation resin of dicyclopentadiene and a phenol compound; an alicyclic epoxy resin such as vinylcyclohexene diepoxide, 3,4-epoxycyclohexylmethyl-3,4-epoxycyclohexanecarboxylate, 2-(3,4-epoxy)cyclohexyl-5,5-spiro(3,4-epoxy)cyclohexane-m-dioxane, in which an olefin bond in the molecule is epoxidized; a paraxylylene-modified epoxy resin which is a glycidyl ether of paraxylylene-modified phenol resin; a metaxylylene-modified epoxy resin which is a glycidyl ether of metaxylylene-modified phenol resin; a terpene-modified epoxy resin which is a glycidyl ether of a terpene-modified phenol resin; a dicyclopentadiene-modified epoxy resin which is a glycidyl ether of a dicyclopentadiene-modified phenol resin; a cyclopentadiene-modified epoxy resin which is a glycidyl ether of a cyclopentadiene-modified phenol resin; a polycyclic aromatic ring-modified epoxy resin which is a glycidyl ether of a polycyclic aromatic ring-modified phenol resin; a naphthalene-type epoxy resin which is a glycidyl ether of a naphthalene ring-containing phenol resin; a halogenated phenol novolac-type epoxy resin; a hydroquinone-type epoxy resin; a trimethylolpropane-type epoxy resin; a linear aliphatic epoxy resin obtained by oxidizing an olefin bond with a peracid such as peracetic acid; an aralkyl-type epoxy resin obtained by epoxidizing an aralkyl-type phenol resin such as phenol aralkyl resin, naphthol aralkyl resin. Furthermore, epoxidized products of acrylic resin may also be examples of the epoxy resin. The epoxy resin may be used alone or in combination of two or more types.

The epoxy equivalent (molecular weight/number of epoxy groups) of the epoxy resin is not particularly limited. From the viewpoint of balancing various properties such as moldability, reflow resistance, and electrical reliability, the epoxy equivalent of the epoxy resin is preferably 100 g/eq to 1000 g/eq, and more preferably 150 g/eq to 500 g/eq.

The epoxy equivalent of the epoxy resin is defined as a value measured according to the method conforming to JIS K 7236:2009.

In the case where the epoxy resin is solid, the softening point or the melting point of the epoxy resin is not particularly limited. From the viewpoint of moldability and reflow resistance, the softening point or the melting point of the epoxy resin is preferably 40° C. to 180° C., and from the viewpoint of handling during the preparation of the resin composition, the softening point or the melting point of the epoxy resin is more preferably 50° C. to 130° C.

The melting point or the softening point of the epoxy resin is defined as a value measured by differential scanning calorimetry (DSC) or by a method (ring and ball method) conforming to JIS K 7234:1986.

In the case where the resin composition includes epoxy resin as the curable resin, the mass ratio of the epoxy resin in the total amount of the resin composition is preferably 0.5 mass % to 30 mass % from the viewpoint of strength, fluidity, heat resistance, moldability, etc. The mass ratio is more preferably 2 mass % to 20 mass %, and even more preferably 3.5 mass % to 13 mass %.

### —Curing Agent—

In the case where the resin composition includes epoxy resin as the curable resin, the resin composition may further include a curing agent.

From the viewpoint of reducing the dielectric loss tangent of the cured product, it is preferable that the resin composition includes an active ester compound as a curing agent. The active ester compound may be used alone or in combination of two or more types. Here, an active ester compound refers to a compound that possesses one or more ester groups in a single molecule that react with an epoxy group and has a curing effect on the epoxy resin. In the case where the curing agent includes an active ester compound, the curing agent may or may not include a curing agent other than the active ester compound.

By using an active ester compound as a curing agent, the dielectric loss tangent of the cured product can be suppressed to be lower than the case where other curing agents (for example, phenol curing agents) are used. The reason for this is presumed to be as follows.

In the reaction between the epoxy resin and the phenol curing agent, a secondary hydroxyl group is generated. Comparatively, in the reaction between epoxy resin and the active ester compound, an ester group is generated instead of a secondary hydroxyl group. Since the ester group has a lower polarity than the secondary hydroxyl group, a resin composition including an active ester compound as a curing agent can suppress the dielectric loss tangent of the cured product to be lower than a resin composition including only a curing agent that generates a secondary hydroxyl group as a curing agent.

Furthermore, polar groups in the cured product increase the water absorption of the cured product. By using an active ester compound as a curing agent, the polar group concentration in the cured product can be suppressed, and the water absorption of the cured product can be inhibited. By suppressing the water absorption of the cured product, in other words, by suppressing the content of H₂O that is a polar molecule, the dielectric loss tangent of the cured product can be further suppressed to be lower.

The active ester compound is not particularly limited in the type thereof as long as the active ester compound is a compound having one or more ester groups in the molecule that react with the epoxy group. Examples of the active ester compound include phenol ester compounds, thiophenol ester compounds, N-hydroxyamine ester compounds, and esterified heterocyclic hydroxy compounds.

Examples of the active ester compound include ester compounds obtained from at least one of aliphatic carboxylic acid and aromatic carboxylic acid, and at least one of an aliphatic hydroxy compound and an aromatic hydroxy compound. The ester compound that includes an aliphatic compound as a component of polycondensation tends to have excellent compatibility with an epoxy resin due to the presence of an aliphatic chain. The ester compound that includes an aromatic compound as a component of polycondensation tends to have excellent heat resistance due to the presence of an aromatic ring.

A specific example of the active ester compound includes an aromatic ester obtained by a condensation reaction between aromatic carboxylic acid and a phenolic hydroxyl group. Among the above, an aromatic ester obtained by a condensation reaction between an aromatic carboxylic acid and a phenolic hydroxyl group is preferred, by using as raw materials a mixture of: an aromatic carboxylic acid component in which 2 to 4 hydrogen atoms of an aromatic ring are substituted with carboxyl groups, such as benzene, naphthalene, biphenyl, diphenylpropane, diphenylmethane, diphenyl ether, diphenylsulfonic acid, etc.; a monovalent phenol in which one hydrogen atom of the aromatic ring is substituted with a hydroxyl group; and a polyvalent phenol in which 2 to 4 hydrogen atoms of the aromatic ring are substituted with hydroxyl groups. In other words, an aromatic ester having a structural unit derived from the aromatic carboxylic acid component, a structural unit derived from the monovalent phenol, and a structural unit derived from the polyvalent phenol is preferred.

As a specific example of the active ester compound, examples may include an active ester resin having a structure obtained by reacting a phenol resin having a molecular structure in which phenol compounds are linked via an aliphatic cyclic hydrocarbon group, an aromatic dicarboxylic acid or a halide thereof, and an aromatic monohydroxy compound, as described in Japanese Patent Application Laid-Open Publication No. 2012-246367. As the active ester resin, a compound represented by the following structural formula (1) is preferred.

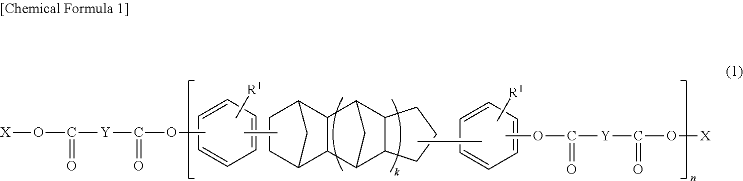

In Structural Formula (1), R¹ is a hydrogen atom, an alkyl group having 1 to 4 carbon atoms, or a phenyl group; X is an unsubstituted benzene ring, an unsubstituted naphthalene ring, a benzene ring or a naphthalene ring substituted with an alkyl group having 1 to 4 carbon atoms, or is a biphenyl group; Y is a benzene ring, a naphthalene ring, or a benzene ring or a naphthalene ring substituted with an alkyl group having 1 to 4 carbon atoms; k is 0 or 1; and n represents the average number of repetitions and is 0.25 to 1.5.

As specific examples of compounds represented by Structural Formula (1), exemplary compounds (1-1) to (1-10) shown below can be listed. In the Structural Formulas, t-Bu represents a tert-butyl group.

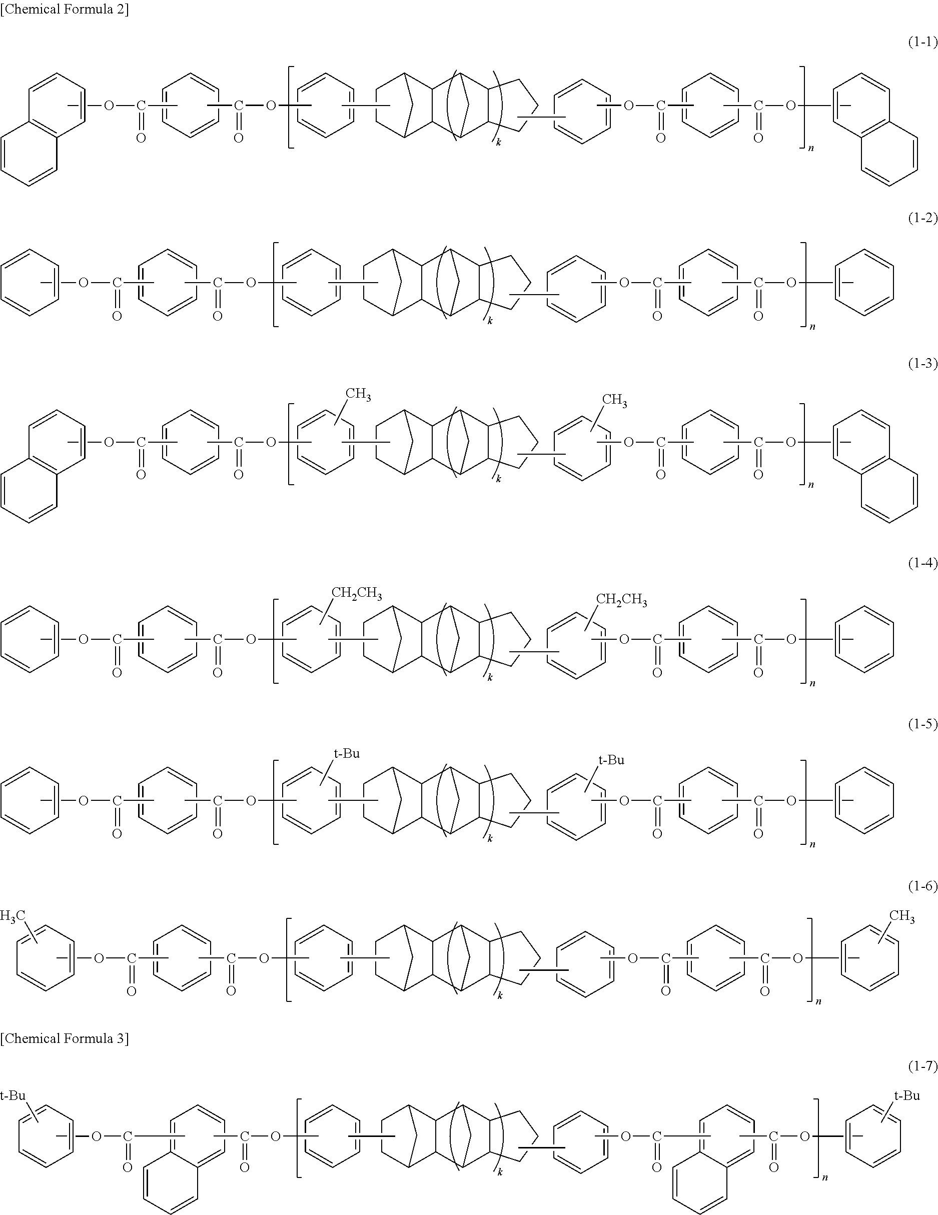

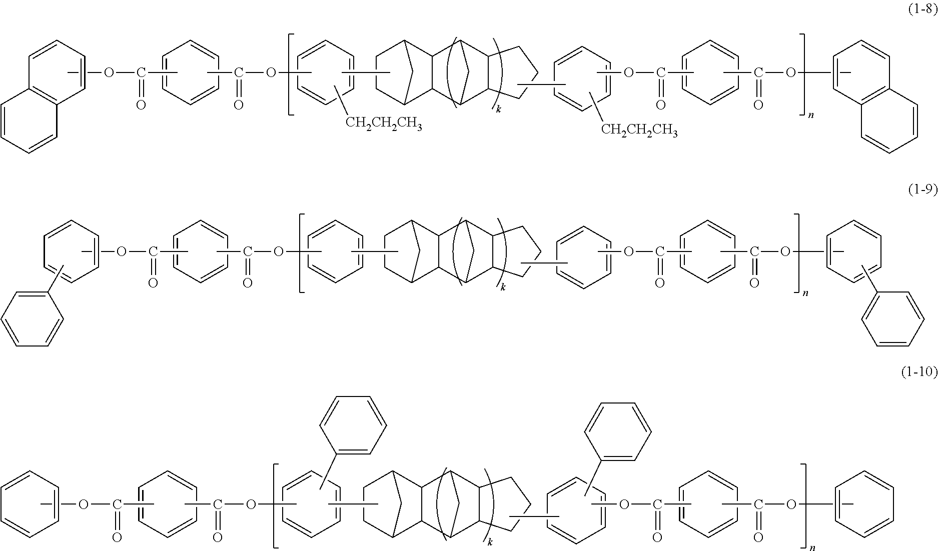

As another specific example of the active ester compound, examples may include compounds represented by the following Structural Formula (2) and compounds represented by the following Structural Formula (3), as described in Japanese Patent Application Laid-Open Publication No. 2014-114352.

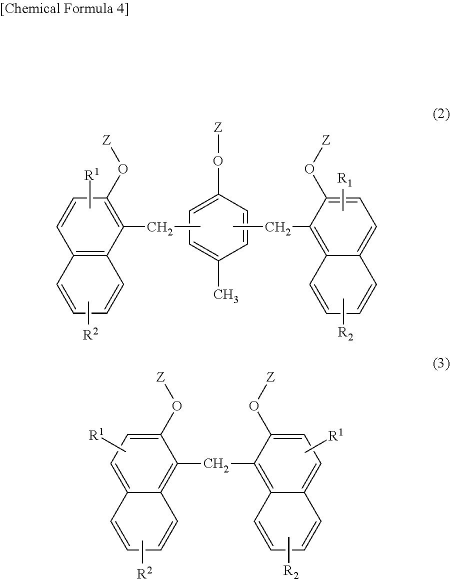

In Structural Formula (2), R¹ and R² are each independently a hydrogen atom, an alkyl group having 1 to 4 carbon atoms, or an alkoxy group having 1 to 4 carbon atoms; Z is an ester-forming structural part (z1) selected from the group consisting of an unsubstituted benzoyl group, an unsubstituted naphthoyl group, a benzoyl group or naphthoyl group substituted with an alkyl group having 1 to 4 carbon atoms, and an acyl group having 2 to 6 carbon atoms, or a hydrogen atom (z2); and at least one of Z is the ester-forming structural part (z1).

In Structural Formula (3), R¹ and R² are each independently a hydrogen atom, an alkyl group having 1 to 4 carbon atoms, or an alkoxy group having 1 to 4 carbon atoms; Z is an ester-forming structural part (z1) selected from the group consisting of an unsubstituted benzoyl group, an unsubstituted naphthoyl group, a benzoyl group or naphthoyl group substituted with an alkyl group having 1 to 4 carbon atoms, and an acyl group having 2 to 6 carbon atoms, or a hydrogen atom (z2); and at least one of Z is the ester-forming structural part (z1).

As specific examples of compounds represented by Structural Formula (2), exemplary compounds (2-1) to (2-6) shown below can be listed.

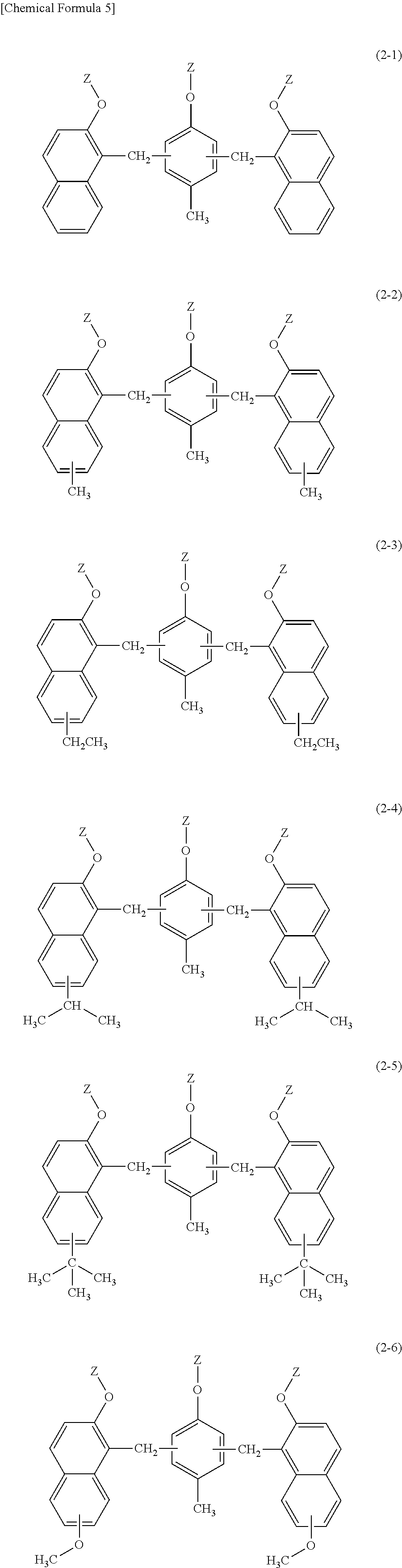

As specific examples of compounds represented by Structural Formula (3), exemplary compounds (3-1) to (3-6) shown below can be listed.

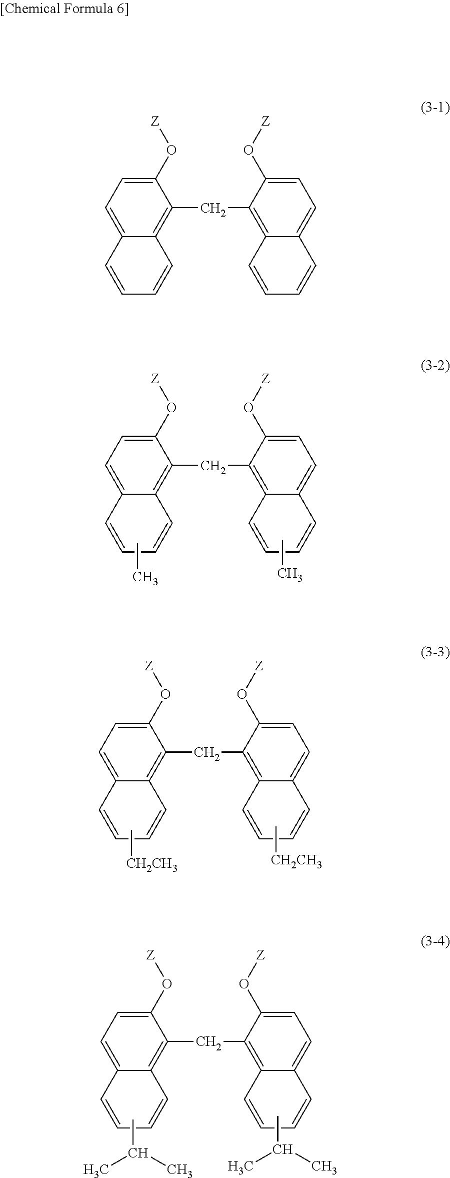

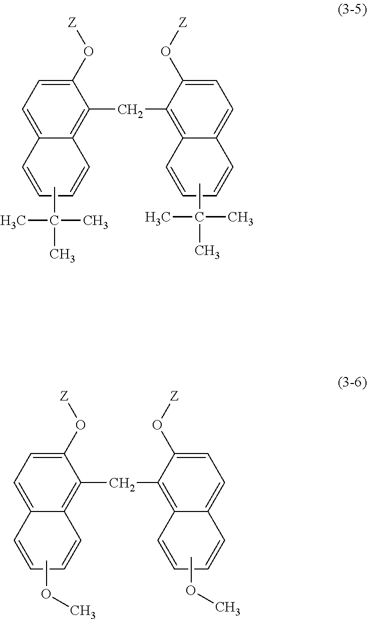

Commercially available products may be used as the active ester compound. Examples of the commercially available active ester compound include: “EXB9451”, “EXB9460”, “EXB9460S”, “HPC-8000-65T” (manufactured by DIC Corporation) as an active ester compound including a dicyclopentadiene-type diphenol structure; “EXB9416-70BK”, “EXB-8”, “EXB-9425” (manufactured by DIC Corporation) as an active ester compound including an aromatic structure; “DC808” (manufactured by Mitsubishi Chemical Corporation) as an active ester compound including an acetylated phenol novolac; “YLH1026” (manufactured by Mitsubishi Chemical Corporation) as an active ester compound including a benzoylated phenol novolac; and the like.

The ester equivalent (molecular weight/number of ester groups) of the active ester compound is not particularly limited. From the viewpoint of balancing various properties such as moldability, reflow resistance, and electrical reliability, 150 g/eq to 400 g/eq is preferable, 170 g/eq to 300 g/eq is more preferable, and 200 g/eq to 250 g/eq is even more preferable.

The ester equivalent of the active ester compound is defined as a value measured according to the method conforming to JIS K 0070:1992.

The curing agent may include other curing agents in addition to the active ester compound. The types of other curing agents are not particularly limited and can be selected according to the desired properties of the resin composition. Examples of other curing agents include phenol curing agents, amine curing agents, acid anhydride curing agents, polymercaptan curing agents, polyaminoamide curing agents, isocyanate curing agents, blocked isocyanate curing agents, and the like.

Specific examples of the phenol curing agent include: a polyphenol compound such as resorcinol, catechol, bisphenol A, bisphenol F, substituted or unsubstituted biphenol; a novolac-type phenol resin obtained by condensation or co-condensation under an acidic catalyst of at least one phenolic compound selected from the group consisting of a phenol compound such as phenol, cresol, xylenol, resorcinol, catechol, bisphenol A, bisphenol F, phenylphenol, aminophenol, and a naphthol compound such as α-naphthol, β-naphthol, dihydroxynaphthalene, with an aldehyde compound such as formaldehyde, acetaldehyde, propionaldehyde; an aralkyl-type phenol resin such as phenol aralkyl resin and naphthol aralkyl resin synthesized from the phenolic compound and dimethoxy paraxylene, bis(methoxymethyl)biphenyl, etc.; a paraxylylene-modified phenol resin, a metaxylylene-modified phenol resin; a melamine-modified phenol resin; a terpene-modified phenol resin; a dicyclopentadiene-type phenol resin and a dicyclopentadiene-type naphthol resin synthesized by copolymerization of the phenolic compound with dicyclopentadiene; a cyclopentadiene-modified phenol resin; a polycyclic aromatic ring-modified phenol resin; a biphenyl-type phenol resin; a triphenylmethane-type phenol resin obtained by condensation or co-condensation under an acidic catalyst of the phenolic compound with an aromatic aldehyde compound such as benzaldehyde, salicylaldehyde; and phenol resin obtained by copolymerization of two or more of types. The phenol curing agents can be used alone or in combination of two or more.

The functional group equivalent (the hydroxyl group equivalent in the case of phenol curing agent) of other curing agents is not particularly limited. From the perspective of balancing various properties such as moldability, reflow resistance, and electrical reliability, the functional group equivalent of other curing agents is preferably 70 g/eq to 1000 g/eq, and more preferably 80 g/eq to 500 g/eq.

The functional group equivalent (the hydroxyl group equivalent in the case of the phenol curing agent) of other curing agents is defined as the value measured according to the method conforming to JIS K 0070:1992.

The softening point or the melting point of the curing agent is not particularly limited. From the perspective of moldability and reflow resistance, the softening point or the melting point of the curing agent is preferably 40° C. to 180° C., and from the perspective of handling during the manufacture of the resin composition, the softening point or the melting point is more preferably 50° C. to 130° C.

The melting point or the softening point of the curing agent is defined as a value measured in the same manner as the melting point or the softening point of the epoxy resin.

The equivalent ratio of the epoxy resin to the curing agent (all the curing agents in the case where multiple types of curing agents are used), that is, the ratio of the number of functional groups in the curing agent to the number of functional groups in the epoxy resin (number of functional groups in the curing agent/number of functional groups in the epoxy resin), is not particularly limited. From the perspective of suppressing the respective unreacted portions, the ratio is preferably set in the range of 0.5 to 2.0, and more preferably set in the range of 0.6 to 1.3. From the perspective of moldability and reflow resistance, it is further preferably set in the range of 0.8 to 1.2.

In the case where the curing agent includes an active ester compound and other curing agents, the mass ratio of the active ester compound in the total amount of the active ester compound and other curing agents is preferably 40 mass % or more, more preferably 50 mass % or more, and further preferably 60 mass % or more, from the perspective of suppressing the dielectric loss tangent of the cured product to a low level.

### (Curing Accelerator)

The resin composition may include a curing accelerator. The type of curing accelerator is not particularly limited and can be selected according to the type of the curable resin, the desired properties of the resin composition, etc.

As the curing accelerator for use in the resin composition including at least one selected from the group consisting of an epoxy resin and a polyimide resin as the curable resin, examples may include: diazabicycloalkene such as 1,5-diazabicyclo[4.3.0]non-5-ene (DBN), 1,8-diazabicyclo[5.4.0]undec-7-ene (DBU); a cyclic amidine compound such as 2-methylimidazole, 2-phenylimidazole, 2-phenyl-4-methylimidazole, 2-ethyl-4-methylimidazole, 2-heptadecylimidazole; a derivative of the cyclic amidine compound; a phenol novolac salt of the cyclic amidine compound or the derivative thereof; a compound having intramolecular polarization formed by adding to the compound a compound with a R-bond such as maleic anhydride, 1,4-benzoquinone, 2,5-toluquinone, 1,4-naphthoquinone, 2,3-dimethylbenzoquinone, 2,6-dimethylbenzoquinone, 2,3-dimethoxy-5-methyl-1,4-benzoquinone, 2,3-dimethoxy-1,4-benzoquinone, phenyl-1,4-benzoquinone, and diazophenylmethane; a cyclic amidinium compound such as tetraphenylborate salt of DBU, tetraphenylborate salt of DBN, tetraphenylborate salt of 2-ethyl-4-methylimidazole, and tetraphenylborate salt of N-methylmorpholine, etc.; a tertiary amine compound such as pyridine, triethylamine, triethylenediamine, benzyldimethylamine, triethanolamine, dimethylaminoethanol, tris(dimethylaminomethyl)phenol; a derivative of the tertiary amine compound; an ammonium salt compound such as tetra-n-butylammonium acetate, tetra-n-butylammonium phosphate, tetraethylammonium acetate, tetra-n-hexylammonium benzoate, tetrapropylammonium hydroxide; an organic phosphine such as primary phosphines like ethylphosphine and phenylphosphine, secondary phosphines like dimethylphosphine and diphenylphosphine, tertiary phosphines like triphenylphosphine, diphenyl(p-tolyl)phosphine, tris(alkylphenyl)phosphine, tris(alkoxyphenyl)phosphine, tris(alkyl-alkoxyphenyl)phosphine, tris(dialkylphenyl)phosphine, tris(trialkylphenyl)phosphine, tris(tetraalkylphenyl)phosphine, tris(dialkoxyphenyl)phosphine, tris(trialkoxyphenyl)phosphine, tris(tetraalkoxyphenyl)phosphine, trialkylphosphine, dialkylalylphosphine, alkyldiarylphosphine, trinaphthylphosphine, tris(benzyl)phosphine; a phosphine compound such as a complex of the organic phosphine with an organic boron; a compound having intramolecular polarization formed by adding to the organic phosphine or phosphine compound a compound with a n-bond such as maleic anhydride, 1,4-benzoquinone, 2,5-toluquinone, 1,4-naphthoquinone, 2,3-dimethylbenzoquinone, 2,6-dimethylbenzoquinone, 2,3-dimethoxy-5-methyl-1,4-benzoquinone, 2,3-dimethoxy-1,4-benzoquinone, phenyl-1,4-benzoquinone, anthraquinone, and diazophenylmethane; a compound having intramolecular polarization obtained through a dehydrohalogenation process after reacting the organic phosphine or phosphine compound with a halogenated phenol compound such as 4-bromophenol, 3-bromophenol, 2-bromophenol, 4-chlorophenol, 3-chlorophenol, 2-chlorophenol, 4-iodophenol, 3-iodophenol, 2-iodophenol, 4-bromo-2-methylphenol, 4-bromo-3-methylphenol, 4-bromo-2,6-dimethylphenol, 4-bromo-3,5-dimethylphenol, 4-bromo-2,6-di-tert-butylphenol, 4-chloro-1-naphthol, 1-bromo-2-naphthol, 6-bromo-2-naphthol, 4-bromo-4′-hydroxybiphenyl; a tetra-substituted phosphonium compound, such as tetra-substituted phosphonium such as a tetraphenylphosphonium; tetraphenylborate salt of tetra-substituted phosphonium such as tetraphenylphosphonium tetra-p-tolylborate; tetraphenylborate salts of tetra-substituted phosphonium, a salt of tetra-substituted phosphonium with a phenolic compound. a salt of tetraalkylphosphonium with a portion of a hydrolysis product of aromatic carboxylic acid anhydride; a phosphobetaine compound; an adduct of a phosphonium compound with a silane compound.

The curing accelerator may be used alone or in combination of two or more types.

Among the above, it is preferable that the curing accelerator is a curing accelerator including organic phosphine. As the curing accelerator including organic phosphine, examples may include the organic phosphine, a phosphine compound such as a complex of the organic phosphine with an organic boron compound, a compound having intramolecular polarization formed by adding a compound having a π-bond to the organic phosphine or the phosphine compound, etc.

Among the above, as a particularly preferable curing accelerator, examples may include triphenylphosphine, an adduct of triphenylphosphine with a quinone compound, an adduct of tributylphosphine with a quinone compound, an adduct of tri-p-tolylphosphine with a quinone compound, and the like.

In the case where the resin composition includes the curing accelerator, the amount thereof is preferably 0.1 parts by mass to 30 parts by mass, and more preferably 1 part by mass to 15 parts by mass, with respect to 100 parts by mass of the resin component (the total amount of the curable resin and the curing agent included as necessary, the same applies hereinafter). When the amount of the curing accelerator is 0.1 parts by mass or more with respect to 100 parts by mass of the resin component, there is a tendency for favorable curing in a short time. When the amount of the curing accelerator is 30 parts by mass or less with respect to 100 parts by mass of the resin component, and there is a tendency for the curing speed not to be too fast and a favorable molded product to be obtained.

### (Inorganic Filler)

The resin composition may include an inorganic filler.

Specifically, as the inorganic filler, examples of inorganic materials may include: crystalline silica, fused silica, alumina, calcium titanate, barium titanate, glass, calcium carbonate, zirconium silicate, calcium silicate, silicon nitride, aluminum nitride, boron nitride, beryllia, zirconia, zircon, forsterite, steatite, spinel, mullite, titania, talc, clay, mica, and the like.

The resin composition may use an inorganic filler having a flame-retardant effect. As the inorganic filler having a flame-retardant effect, examples may include: aluminum hydroxide, magnesium hydroxide, composite metal hydroxide such as composite hydroxide of magnesium and zinc, zinc borate, and the like.

The inorganic filler may be used alone or in combination of two or more types.

From the viewpoint of enhancing the thermal conductivity of the cured product, it is preferable that the resin composition includes alumina particles as the inorganic filler.

From the viewpoint of enhancing the relative dielectric constant of the cured product, it is preferable that the resin composition includes at least one selected from the group consisting of calcium titanate particles and barium titanate particles as inorganic fillers. From the viewpoint of enhancing the relative dielectric constant while reducing the dielectric loss tangent of the cured product, it is preferable that the resin composition contains calcium titanate particles as the inorganic filler.

The inorganic filler that enhances the relative dielectric constant of the cured product is, for example, suitable in the case of using the resin composition for manufacturing an antenna-in-package type electronic component device to be described in the following.

In the case where the resin composition includes alumina particles, the content ratio of the alumina particles is preferably 30 mass % to 90 mass %, more preferably 40 mass % to 80 mass %, and even more preferably 50 mass % to 70 mass %, with respect to the total inorganic filler.

In the case where the resin composition includes at least one selected from the group consisting of calcium titanate particles and barium titanate particles, the total content ratio of calcium titanate particles and barium titanate particles is preferably 10 mass % to 60 mass %, more preferably 20 mass % to 50 mass %, and even more preferably 30 mass % to 40 mass %, with respect to the total inorganic filler.

The volume average particle size of the inorganic filler is preferably 0.1 μm to 100 μm, more preferably 0.2 μm to 80 μm, and even more preferably 0.5 μm to 30 μm.

The resin composition may contain two or more types of inorganic fillers with different volume average particle sizes.

The volume average particle size of the inorganic filler is defined as the particle size at the cumulative value of 50% (volume basis) in the particle size distribution obtained through laser diffraction/scattering. The particle size distribution is measured, for example, as follows.

First, the inorganic filler is added to a dispersion medium (water) in the range of 0.01 mass % to 0.1 mass %, and dispersed for 5 minutes by using a bath-type ultrasonic cleaner. Then, 5 ml of the obtained dispersion liquid is injected into a cell, and the particle size distribution is measured at 25° C. by using the laser diffraction/scattering particle size distribution analyzer (LA920, HORIBA, Ltd.).

The content ratio of the inorganic filler is preferably 40 volume % to 90 volume %, more preferably 50 volume % to 85 volume %, and even more preferably 60 volume % to 80 volume %, with respect to the total resin composition.

The content ratio (volume %) of the inorganic filler in the resin composition can be calculated from the mass and the density of each material included in the resin composition in the case where the composition of the resin composition is known. In the case where the composition of the resin composition is unknown, the content ratio (volume %) of the inorganic filler can be determined by the following method.

A thin slice sample of the cured product of the resin composition is imaged by using a scanning electron microscope (SEM). In the SEM image, an arbitrary area S is identified, and a total area A of the inorganic filler contained in the area S is determined. The value obtained by dividing the total area A of the inorganic filler by the area S is converted to a percentage (%), and the value is considered as the content ratio (volume %) of the inorganic filler in the resin composition.

The area S should be sufficiently larger than the size of the inorganic filler. For example, the area S should be large enough to contain 100 or more inorganic fillers. The area S may be the sum of multiple cross-sectional areas.

In the inorganic filler, a bias may be present in the presence ratio in the gravity direction during the curing of the resin composition. In such a case, when imaging with SEM, the entirety of the cured product in the gravity direction is imaged, and the area S that includes the entirety of the cured product in the gravity direction is identified.

### [Various Additives]

The resin composition may include, in addition to the above components, various additives exemplified below, such as a coupling agent, an ion exchanger, a release agent, a flame retardant, a stress relief agent, a fluidity-imparting agent, and the like. The resin composition may also contain include additives familiar for those in the technical field as needed, in addition to the additives exemplified below.

### (Coupling Agent)

The resin composition may include a coupling agent. The coupling agent is not particularly limited, and conventional coupling agents may be used. Specifically, examples may include a silane-based compound such as epoxysilane, mercaptosilane, aminosilane, ureidosilane, vinylsilane, disilazane, a titanium-based compound, a aluminum chelate-based compound, an aluminum/zirconium-based compound, and the like.

In the case where the resin composition includes a coupling agent, the amount of the coupling agent is preferably 0.05 parts by mass to 5 parts by mass, and more preferably 0.1 parts by mass to 2.5 parts by mass, with respect to 100 parts by mass of the inorganic filler.

### (Ion Exchanger)

The resin composition may include an ion exchanger. The ion exchanger is not particularly limited, and conventional ion exchangers can be used. Specifically, examples may include a hydrotalcite compound, and a hydrated hydroxide of at least one element selected from the group consisting of magnesium, aluminum, titanium, zirconium, and bismuth. The ion exchanger may be used alone or in combination of two or more types. Among the above, hydrotalcite represented by the following general formula (A) is preferred.

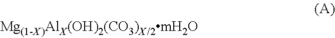

(0<X≤0.5, m being a positive number)

In the case where the resin composition includes an ion exchanger, the content of the ion exchanger is preferably 0.1 parts by mass to 30 parts by mass, and more preferably 1 part by mass to 10 parts by mass, with respect to 100 parts by mass of the resin component.

### (Release Agent)

The resin composition may include a release agent. The release agent is not particularly limited, and conventional release agents may be used. Specifically, examples may include carnauba wax, montan acid, a higher fatty acid such as stearic acid, a metal salt of a higher fatty acid, an ester-based wax such as montan acid ester, a polyolefin-based wax such as oxidized polyethylene and non-oxidized polyethylene. The release agent may be used alone or in combination of two or more types.

In the case where the resin composition includes a release agent, the amount is preferably 0.01 parts by mass to 10 parts by mass, and more preferably 0.1 parts by mass to 5 parts by mass, with respect to 100 parts by mass of the resin component.

### (Flame Retardant)

The resin composition may include a flame retardant. The flame retardant is not particularly limited, and conventionally flame retardants can be used. Specifically, examples may include an organic or inorganic compound containing halogen atoms, antimony atoms, nitrogen atoms or phosphorus atoms, and metal hydroxides. The flame retardant may be used alone or in combination of two or more types.

In the case where the resin composition includes a flame retardant, the amount of the flame retardant is preferably 1 part by mass to 30 parts by mass, and more preferably 2 parts by mass to 20 parts by mass, with respect to 100 parts by mass of the resin component.

### (Stress Relief Agent)

The resin composition may include a stress relief agent. By including a stress relief agent in the resin composition, the warpage deformation of the package and the occurrence of package cracks can be further reduced. As the stress relief agent, conventionally stress relief agents (flexibilizers) that are generally used can be listed. Specifically, examples may include a thermoplastic elastomer such as a silicone-based, styrene-based, olefin-based, urethane-based, polyester-based, polyether-based, polyamide-based, polybutadiene-based elastomer; rubber particles such as natural rubber (NR), acrylonitrile-butadiene rubber (NBR), acrylic rubber, urethane rubber, silicone powder; rubber particles having a core-shell structure such as methyl methacrylate-styrene-butadiene copolymer (MBS), methyl methacrylate-silicone copolymer, methyl methacrylate-butyl acrylate copolymer. The stress relief agent may be used alone or in combination of two or more types.

Among the stress relief agents, a silicone-based stress relief agent is preferred. As the silicone-based stress relief agent, those having an epoxy group, those having amino groups, and those modified with polyether, and a silicone compound such as a silicone compound having an epoxy group and a polyether-based silicone compound are more preferred.

In the case where the resin composition includes a stress relief agent, the amount of the stress relief agent is preferably 1 part by mass to 30 parts by mass, and more preferably 2 parts by mass to 20 parts by mass, with respect to 100 parts by mass of the resin component.

### (Fluidity-Imparting Agent)

The resin composition may include a fluidity-imparting agent. Specifically, as the fluidity-imparting agent, examples may include indene-coumarone resin, triphenylphosphine oxide, etc.

In the case where the resin composition contains a fluidity-imparting agent, the amount of the fluidity-imparting agent is, for example, preferably 1 part by mass to 30 parts by mass, and more preferably 2 parts by mass to 20 parts by mass, with respect to 100 parts by mass of the resin component.

The resin composition is preferably a solid under normal temperature and pressure conditions (for example, at 25° C. and atmospheric pressure). In the case where the resin composition is a solid, the shape of the resin composition is not particularly limited, and examples may include a powder form, a granular form, a tablet form, etc. In the case where the resin composition is in a tablet form, it is preferable from the viewpoint of handling that the dimension and the mass match the molding conditions of the package.

### (Various Properties of the Resin Composition)

As the dielectric loss tangent at 10 GHz of the cured product obtained by molding the resin composition through compression molding under the condition of a mold temperature of 175° C., a molding pressure of 6.9 MPa, and a curing time of 600 seconds. For example, the dielectric loss tangent may be 0.020 or less. The dielectric loss tangent at 10 GHz of the cured product is preferably 0.018 or less, more preferably 0.015 or less, and even more preferably 0.010 or less from the viewpoint of reducing transmission loss. The lower limit of the dielectric loss tangent at 10 GHz of the cured product is not particularly limited. For example, the lower limit of the dielectric loss tangent may be 0.004, for example.

The dielectric loss tangent is measured by the method described in the examples.

The flow distance when the resin composition is molded by using a spiral flow measurement mold in accordance with EMMI-1-66 under conditions of a mold temperature of 175° C., a molding pressure of 6.9 MPa, and a curing time of 90 seconds is preferably 60 cm or more, more preferably 70 cm or more, and even more preferably 80 cm or more. Hereinafter, the flow distance is also referred to as “spiral flow”. The upper limit of the spiral flow is not particularly limited. For example, the upper limit may be 200 cm.

The spiral flow is measured by using the method described in the examples.

The gel time of the resin composition at 175° C. is preferably 30 seconds or more to 100 seconds, and more preferably 40 seconds to 70 seconds.

The measurement of the gel time of the resin composition at 175° C. is performed as follows. Specifically, for a sample of 3 g of the resin composition, a measurement is conducted by using a Curast-o-meter from JSR Trading Co., Ltd. at a temperature of 175° C., and the time until the rise of the torque curve is defined as the gel time (sec).

The gel time is measured by the method described in the examples.

### (Uses of the Resin Composition)

According to the resin composition of the embodiment, a cured product with reduced dielectric loss tangent can be obtained. Therefore, the resin composition of the embodiment is suitable as a sealing material for an electronic component device that uses high-frequency radio waves for communication.

As an electronic component device that uses high-frequency radio waves for communication, the development of Antenna in Package (AiP), which is a package with antenna functionality, is also progressing. In AiP, to cope with the increase in the number of channels due to the diversification of information, the radio waves used for communication are become higher in frequency, and the sealing material is required to achieve a high relative dielectric constant and a low dielectric loss tangent.

Materials that increase the relative dielectric constant of the cured product of the resin composition (i.e., materials with high relative dielectric constant) generally tend to also increase the dielectric loss tangent of the cured product. The resin composition of the embodiment can reduce the dielectric loss tangent of the cured product by including specific carbon particles. Therefore, even when materials that increase the relative dielectric constant of the cured product are used, the increase in dielectric loss tangent can be suppressed. Therefore, the resin composition of the embodiment is also suitable as the sealing material for an electronic component device such as AiP, which requires a high relative dielectric constant as well as a low dielectric loss tangent.

### <Manufacturing Method of the Resin Composition>

The manufacturing method of the resin composition according to an embodiment of the disclosure includes mixing a curable resin and carbon particles, the carbon particles satisfying at least one of the following (1) and (2).
(1) The pH is 5.0 or less.
(2) The average particle size is 80 nm or more.

According to the method, a resin composition with a low dielectric loss tangent of the cured product can be obtained.

The method of mixing the curable resin and the carbon particles is not particularly limited. Examples may include a method of mixing the curable resin, the carbon particles, and other components included as necessary by using a mixer, etc.

After the curable resin and the carbon particles are mixed, processes such as melt kneading, cooling, grinding, and tableting of the mixture may be performed as necessary.

The resin composition manufactured by the method may be the resin composition according to an embodiment of the disclosure. Therefore, the details and preferred aspects of the resin composition manufactured by the method may be the same as the details and preferred aspects of the resin composition according to an embodiment of the disclosure described above.

### <Electronic Component Device>

The electronic component device according to an embodiment of the disclosure includes a support member, an electronic component disposed on the support member, and a cured product of the resin composition sealing the electronic component.

Examples of the electronic component device may include a device (e.g., a high-frequency device) in which an electronic component region obtained by mounting an electronic components (an active element such as a semiconductor chip, a transistor, a diode, and a thyristor; a passive element such as a capacitor, a resistor, and a coil; an antenna, etc.) on the support member such as a lead frame, a wired tape carrier, a wiring board, a glass, a silicon wafer, an organic substrate, etc., is sealed with the resin composition.

The type of the support member is not particularly limited, and support members generally used in the manufacture of electronic component devices can be used.

The electronic component may include an antenna, or may include both an antenna and elements other than the antenna. The antenna is not limited as long as it serves the role of an antenna, and may be an antenna element or may be a wiring.

In addition, in the electronic component device of the embodiment, if necessary, other electronic components may be disposed on the surface on a side opposite to the surface on which the electronic component is disposed on the support member. Other electronic components may be sealed with the resin composition, sealed with another resin composition, or not sealed.

### <Manufacturing Method of the Electronic Component Device>

The manufacturing method of the electronic component device according to the embodiment includes a step of placing an electronic component on a support member, and a step of sealing the electronic component with the resin composition.

The method for implementing each step is not particularly limited, and can be carried out by general techniques. In addition, the types of the support member and the electronic component used in the manufacture of the electronic component device are not particularly limited, and support members and electronic components generally used in the manufacture of electronic component devices can be used.

The method for sealing the electronic component by using the resin composition includes low-pressure transfer molding, injection molding, and compression molding, etc. Among these, low-pressure transfer molding is common.

### Examples

In the following, the embodiment will be specifically described below with examples, but the scope of the embodiment is not limited to these examples.

### <Preparation of Resin Composition>

The components shown below were mixed in the blending ratios (parts by mass) shown in Table 1 to prepare resin compositions of Examples and Comparative Examples. The obtained resin compositions were solid under normal temperature and pressure conditions.

In Table 1, blank spaces indicate that the component was not included.

Epoxy resin 1: Ortho-cresol novolac type epoxy resin, epoxy equivalent 200 g/eq (DIC Corporation, product name “N500P-2”)

Epoxy resin 2: Biphenyl type epoxy resin, epoxy equivalent 192 g/eq (Mitsubishi Chemical Corporation, product name “YX-4000”)

Epoxy resin 3: Biphenyl aralkyl type epoxy resin, epoxy equivalent 274 g/eq (Nippon Kayaku Co., Ltd., product name “NC-3000”)

Curing agent 1: Active ester compound, DIC Corporation, product name “EXB-8” Curing agent 2: Phenol aralkyl type phenol resin, hydroxyl equivalent 170 g/eq (Meiwa Kasei Co., Ltd., product name “MEHC7851SS”)

Curing accelerator: Triphenylphosphine/1,4-benzoquinone adduct Coupling agent: N-phenyl-3-aminopropyltrimethoxysilane (Shin-Etsu Chemical Co., Ltd., product name “KBM-573”)

Release agent: Montan acid ester wax (Clariant Japan K.K., product name “HW-E”)

Carbon particle 1: Carbon black, pH: 5.8, particle size: 20 nm

Carbon particle 2: Carbon black, pH: 3.2, particle size: 24 nm

Carbon particle 3: Carbon black, pH: 4.4, particle size: 46 nm

Carbon particle 4: Carbon black, pH: 3.5, particle size: 133 nm

Carbon particle 5: Carbon black, pH: 6.4, particle size: 122 nm

Inorganic filler 1: Calcium titanate particles, volume average particle size: 0.2 μm

Inorganic filler 2: Calcium titanate particles, volume average particle size: 15.4 μm

Inorganic filler 3: Alumina particles, volume average particle size: 7 μm

Fluidity auxiliary agent 1: Indene-coumarone resin

Fluidity auxiliary agent 2: Triphenylphosphine oxide

### <Evaluation of Physical Properties of Resin Composition>

### (Dielectric Loss Tangent)

The resin composition was placed in a vacuum hand press machine and molded under the conditions of a mold temperature of 175° C., a molding pressure of 6.9 MPa, and a curing time of 600 seconds, followed by post-curing at 175° C. for 6 hours to obtain a plate-shaped cured product (12.5 mm in length, 25 mm in width, and 0.2 mm in thickness). By using the plate-shaped cured product as a test specimen, a dielectric loss tangent Df at 10 GHz was measured at a temperature of 25±3° C. through a dielectric constant measuring device (Agilent Technologies, product name “Network Analyzer N5227A”). The results are shown in Table 1.

### (Fluidity)

By using a spiral flow measurement mold in accordance with EMMI-1-66, the resin composition was molded under the conditions of a mold temperature of 180° C., a molding pressure of 6.9 MPa, and a curing time of 120 seconds, and the flow distance SF (cm) was determined. The results are shown in Table 1.

### (Gel Time)

A measurement was performed at a temperature of 175° C. on 3 g of the resin composition by using a curelastometer of JSR Trading Co., Ltd., and the time until the rise of the torque curve was defined as the gel time GT (seconds). The results are shown in Table 1.

### (Bending Strength)

The resin compositions obtained in respective Examples and Comparative Example were molded into a rectangular parallelepiped body of 4.0 mm×10.0 mm×80 mm by using a transfer molding machine under the conditions of a mold temperature of 180° C., a molding pressure of 6.9 MPa, and a curing time of 90 seconds, followed by post-curing at 180° C. for 5 hours to prepare test specimens for bending strength evaluation. By using the test specimens, a bending test was conducted with a Tensilon universal material test machine (Instron 5948, Instron Corporation) under the conditions of a support span of 64 mm, a crosshead speed of 10 mm/min, and a temperature of 25° C. Using the measured results, a bending stress-displacement curve was created from Equation (A), and the maximum stress was defined as the bending strength (MPa).

The results are shown in Table 1.

$$σ = 3 FL / 2 {bh}^{2} \qquad Equation ( A )$$

σ: bending stress (MPa)
F: bending load (N)
L: support span (mm)
b: specimen width (mm)
h: specimen thickness (mm)

TABLE 1

| | Comparative | Example | Example | Example | Example | Example | Example | Example |
|---|---|---|---|---|---|---|---|---|
| | Example 1 | 1 | 2 | 3 | 4 | 2 | 5 | 6 |
| Epoxy resin 1 | 70.1 | 70.1 | 70.1 | 70.1 | 70.1 | | | |
| Epoxy resin 2 | 30 | 30 | 30 | 30 | 30 | 30 | 30 | 30 |
| Epoxy resin 3 | | | | | | 70.1 | 70.1 | 70.1 |
| Curing agent 1 | 106 | 106 | 106 | 106 | 106 | 51.7 | 51.7 | 51.7 |
| Curing agent 2 | | | | | | 32.8 | 32.8 | 32.8 |
| Curing accelerator | 5 | 5 | 5 | 5 | 5 | 3 | 3 | 3 |
| Coupling agent | 5 | 5 | 5 | 5 | 5 | 5 | 5 | 5 |
| Release agent | 1 | 1 | 1 | 1 | 1 | 1 | 1 | 1 |
| Carbon particle 1 | 5.3 | | | | | 5.3 | | |
| Carbon particle 2 | | 5.3 | | | | | 5.3 | |
| Carbon particle 3 | | | 5.3 | | | | | |
| Carbon particle 4 | | | | 5.3 | | | | 5.3 |
| Carbon particle 5 | | | | | 5.3 | | | |
| Fluidity auxiliary agent 1 | 10 | 10 | 10 | 10 | 10 | 10 | 10 | 10 |
| Fluidity auxiliary agent 2 | 5 | 5 | 5 | 5 | 5 | 5 | 5 | 5 |
| Filler amount (Vf) | 73 | 73 | 73 | 73 | 73 | 73 | 73 | 73 |
| Inorganic filler 1 | 223 | 223 | 223 | 223 | 223 | 201 | 201 | 201 |
| Inorganic filler 2 | 558 | 558 | 558 | 558 | 558 | 504 | 504 | 504 |
| Inorganic filler 3 | 1378 | 1378 | 1378 | 1378 | 1378 | 1244 | 1244 | 1244 |
| Total | 2396.4 | 2396.4 | 2396.4 | 2396.4 | 2396.4 | 2162.9 | 2162.9 | 2162.9 |
| SF[cm] | 69 | 100 | 90 | 80 | 75 | 55 | 73 | 67 |
| GT[s] | 60 | 60 | 50 | 60 | 60 | 47 | 50 | 47 |
| Df | 0.0057 | 0.0052 | 0.0047 | 0.0051 | 0.0053 | 0.0072 | 0.0068 | 0.0064 |
| Bending strength | 116 | 137 | 125 | 125 | 120 | 103 | 120 | 109 |

As shown in Table 1, when comparing Examples 1 to 4 which used carbon particles 2 to 5 with a pH of 5.0 or less or a particle size of 80 nm or more, and Comparative Example 1 which used carbon particle 1 with a pH exceeding 5.0 and a particle size less than 80 nm but otherwise had the same conditions as Examples 1 to 4, the values of the dielectric loss tangent Df of the cured products of the resin compositions in Examples 1 to 4 were smaller than that of Comparative Example 1.

Similarly, when comparing Examples 5 to 6 which used carbon particles 2 and 4 with a pH of 5.0 or less or a particle size of 80 nm or more, and Comparative Example 2 which used carbon particle 5 with a pH exceeding 5.0 and a particle size less than 80 nm but otherwise had the same conditions as Examples 5 to 6, the values of the dielectric loss tangent Df of the cured products of the resin compositions in Examples 5 to 6 were smaller than that of Comparative Example 2.

Furthermore, in the Examples using carbon particles 2 to 5, the bending strength values of the cured products of the resin compositions were larger than those of Comparative Examples using carbon particle 1. The reason is uncertain, but it is considered that the wettability and adhesion increased with the resin improved due to the presence of many functional groups on the surface of the carbon black.

### <Evaluation of Electrical Conductivity of Carbon Particles>

To compare the electrical conductivity of carbon particles 1 to 5, resin plates (cured products of epoxy resin 3 and curing agent 2) containing 10 volume % of each carbon particle were prepared, and the volume resistivity (Ω·cm) was measured by the double-ring electrode method in accordance with JIS K6911 (2006) and JIS K6271 (2015).

The results are as follows. The volume resistivity of the resin plate without carbon particles was 5.8×10¹⁶ Ω·cm.

Carbon particle 1: 6.6×10⁸ Ω·cm

Carbon particle 2: 7.0×10¹² Ω·cm

Carbon particle 3: 3.6×10¹⁶ Ω·cm

Carbon particle 4: 5.1×10¹⁶ Ω·cm

Carbon particle 5: 3.1×10¹¹ Ω·cm

As shown above, the volume resistivity of the resin plate containing carbon particles 2 to 5, which had a pH of 5.0 or less or an average particle size of 80 nm or more, was larger than the volume resistivity of the resin plate containing carbon particle 1, which had a pH exceeding 5.0 and an average particle size less than 80 nm.

From the above, it can be considered that the low conductivity of carbon particles 2 to 5 is related to the results shown in Table 1, in which the dielectric loss tangent of the cured products in the examples using carbon particles 2 to 5 is lower than Comparative Example using carbon particle 1.

All the literature, patent applications, and technical standards described in the specification are incorporated herein by reference to the same extent as if each individual literature, patent application, and technical standard was specifically and individually indicated to be incorporated by reference.

1. A resin composition, comprising a curable resin and carbon particles, wherein the carbon particles satisfy at least one of (1) and (2) as follows:
(1) a pH is 5.0 or less; and
(2) an average particle size is 80 nm or more.

2. The resin composition as claimed in claim 1, wherein the carbon particles at least satisfy (1).

3. The resin composition as claimed in claim 1, wherein the carbon particles at least satisfy (2).

4. The resin composition as claimed in claim 1, wherein the carbon particles comprise carbon black.

5. The resin composition as claimed in claim 1, wherein the curable resin comprises epoxy resin.

6. An electronic component device, comprising:
a support member;
an electronic component disposed on the support member; and
a cured product of the resin composition as claimed in claim 1 that seals the electronic component.

7. The electronic component device as claimed in claim 6, wherein the electronic component comprises an antenna.

8. A method for manufacturing a resin composition, comprising:
mixing a curable resin and carbon particles, wherein the carbon particles satisfy at least one of (1) and (2) as follows:
(1) a pH is 5.0 or less; and
(2) an average particle size is 80 nm or more.
